(19) United States
(12) Patent Application Publication
(10) Pub. No.: US 2010/0287230 A1
(43) Pub. Date: Nov. 11, 2010

(54) Internet-enabled Data Transceiver

(76) Inventor: Thomas Frederick Stalcup, East Falmouth, MA (US)

Correspondence Address: Thomas Stalcup, 19 Research Rd., East Falmouth, MA, 02536, US

(21) Appl. No.: 12/436,110

(22) Filed: May 5, 2009

(51) Int. Cl. G06F 15/16; H04L 29/06; G06F 9/44; H04M 11/00

(52) U.S. Cl. 709/203; 455/414.3; 717/106; 379/93.01

(57) ABSTRACT

An improved low-power data transceiver with a companion virtual component (a virtual component/clone of the hardware) on the Internet. Users can interact with the virtual component while the physical transceiver is not accessible due to network outages or it being in a low-power, non-transmitting/receiving state. When the physical transceiver comes back online, it will transmit any new information that it is programmed or commanded to transmit and will download and execute any commands sent to its virtual counterpart by the user.

### U.S. PATENT DOCUMENTS

| | | |
|---|---|---|
| 5,838,996 | November 1998 | deCarmo |
| 5,854,841 | December 1998 | Nakata et al. |
| 5,901,310 | May 1999 | Rahman et al. |
| 6,058,210 | May 2000 | de Queiroz et al. |
| 6,078,541 | June 2000 | Kitagawa et al. |
| 6,104,506 | August 2000 | Hirokawa |
| 6,128,094 | October 2000 | Smith |
| 6,988,182 | January 2006 | Teachman, et al. |

### BACKGROUND

Data and information from remote locations is becoming more easily accessible with the decreasing cost of cellular, satellite, and other wireless telemetry. Scientists have been using these wireless networks to access environmental data from remote areas for decades. And now, wireless telephones and personal data assistants (PDA's) are being widely used around the globe.

Regardless of the purpose of the remote device, whether it be a weather station or cellular telephone, each device relies on the same underlying technology for data transfer. Each includes at least one programmable microprocessor and at least one wireless data transceiver for sending and receiving data. In the case of a weather station, environmental data is usually transmitted at a regular, predefined interval to a receiving computer or server. And for those weather stations with two-way data transceivers, the user can reconfigure the weather station by sending remote commands to it.

Cell phone and PDA's are prevalent in most societies today and are ever-evolving. More powerful microprocessors and more memory is providing new and unforeseen functionality. Apple Computer, for example, allows users to create their own custom applications which can be loaded onto and executed on their ‘iPhone’ phone.

In order to load applications or new firmware onto these devices, the user or technician must create the application in a special programming environment, and then that application is compiled into a binary format to be downloaded onto the device either via a computer cable or wirelessly. With new applications being produced regularly and with user requirements changing at a similar rate, the need for user-friendly systems to handle the ever-changing software and firmware landscape for wireless devices is growing.

### SUMMARY

The Internet-enabled data transceiver (IEDT) is an autonomous electronic transmitter and receiver of data to and from the Internet. The data transmitted can be, but is not limited to, live images, video, environmental sensors, and alarms. There are two main components of the transceiver: 1) the physical hardware enabling it to transmit and receive data and 2) its virtual presence on the Internet with which users may interface via a computing device such as a personal computer or mobile device. The transceiver hardware can be interfaced into various mobile or remote electronic devices, such as cellular telephones or remote data metering and/or logging equipment.

The hardware component of the IEDT is designed for 1) low power consumption 2) minimum bandwidth data transmission, and 3) simple and secure installation behind (or circumventing) IT firewalls. The low power consumption will allow it to use smaller and less expensive batteries when batteries are needed, or will require less power from the electrical grid when connected to it. The low bandwidth data transmission will minimize transmission costs and maximize transmission speed over commercial wireless, satellite, or other networks. The secure and simple installation will reduce (or negate) the involvement IT personnel or the need to introduce security risks associated with opening special ports and/or enabling port redirects.

The virtual component of the IEDT allows users to access data transmitted by the hardware quickly and efficiently with computing devices, as well as re-configure and/or re-program the device via a flexible and easy-to-use web interface.

The hardware will include a programmable microprocessor to control the operation of the IEDT, together with interface connectors for digital other devices, cameras/camcorders, sensor networks, analog signals, and digital input/output ports. Depending on the program running and the devices or sensors connected, the IEDT will autonomously transmit data to its virtual counterpart (VC) on the Internet at a pre-programmed interval (transmission rate).

The VC will be a specific Internet address accessible to users by logging onto a web-based user interface with a user ID and password. The user interface side of the VC will display the most current data and status information transmitted by the IEDT, as well as having a control area where users can send control commands to the IEDT. The IEDT side (back end) of the VC will contain a virtual transceiver that can receive and transmit data and information to and from the IEDT. Data received will be stored in a database and/or server folder. Data transmitted will be sent out of a email, folder, or database queue.

During each transmission from the IEDT to the VC, the IEDT will query the VC for any commands generated by the VC or a remote user. If any commands have been queued since the last transmission, they will be retrieved and executed immediately, and then deleted from the queue. Such commands could be instructions to change the transmission rate, download new firmware or drivers, or some other task. If in low-power mode, the IEDT will shut-down all non-essential systems when not in use to conserve power.

Users logged into the VC web interface can access and view data, images, and/or video from the IEDT without actually being connected to the IEDT. Data and information transmitted by the IEDT will be stored on an Internet server within folders and/or databases on said server. The VC will include an automatically generated web-page, complete with graphs of sensor data, IEDT status information, current sensor and/or image data, and a world map with its location marked.

To minimize delays associated with loading Internet images, video, or other data from an Internet server to a user computer or mobile device, a copy of historic data and information from the VC will be stored on user computers and/or mobile devices (space permitting). Whenever the user visits a specific VC's Internet address, any new data stored since the last visit will be automatically downloaded to the user's PC or mobile device.

Users will be able to re-configure and re-program the IEDT by queuing commands at the VC. Once a command is queued, it will be retrieved by the IEDT the next time it transmits to the server. The user will also be able to queue files to load onto the VC through the web interface, as well as write and test low-level computer code for the IEDT via a web-based text editor and an IEDT emulator.

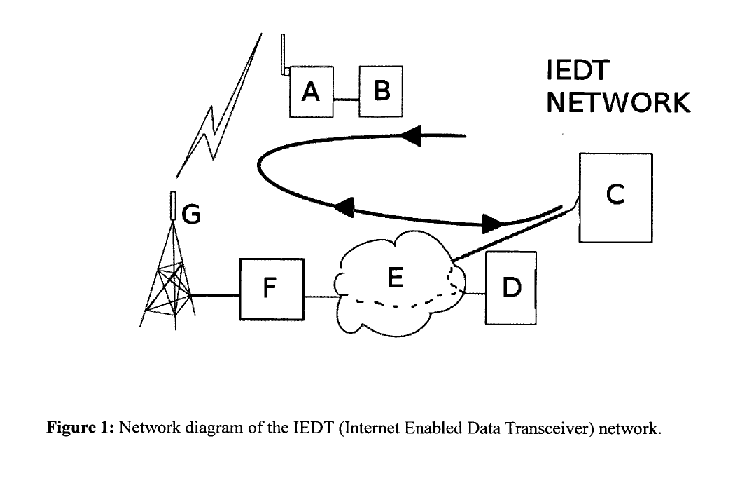

FIG. 1 is a block diagram of the IEDT network, showing the links and connections between the necessary existing infrastructure (such as the Internet). All items in the figure are labeled as follows: A) Internet Enabled Data Transceiver (IEDT); B) weather station, person data assistant (PDA), cellular telephone, or other remote device; C) client web browser; D) the IEDT's Virtual Counterpart (VC) on an Internet server; E) the Internet; F) Internet gateway of the cellular, satellite, or other network provider; and G) Cellular, satellite, or other transmitter between the IEDT and Internet gateway. Note that the client web browser (C) communicates via the Internet directly to the server hosting the IEDT's virtual counterpart (VC) and that the physical transceiver (the IEDT) communicates to the VC over the cellular, satellite, or other network in this embodiment.

U.S. Pat. No. 6,988,182 entitled “Method for upgrading firmware in an electronic device” describes a method of using a text editor to create and load firmware or other applications onto a remote device, but this text editor is built into the remote device. Therefore, the remote device must be powered on to create, compile, and load the new program. This causes two undesired effects: 1) Excess power is consumption during reprogramming, which will significantly reduce the life of any battery, if the device is battery powered; and 2) excess bandwidth and airtime is used while programming, which can be costly for cellular and satellite networks.

The present invention's VC (Virtual Component) solves both problems. By writing, testing, and compiling the program on the VC, which exists in an Internet server, the physical transceiver can remain offline, consuming almost no power and no cellular, satellite, or other bandwidth. And when the physical transceiver turns on and receives a command to download a new program or firmware file, it will download the file as a compressed binary file, further minimizing bandwidth and power consumption.

1. A method for viewing data and images from, as well as controlling and reprogramming a remote data transceiver, comprising: providing at least one satellite data transceiver; at least one sensor, camera, or electrical switch; and, an Internet server with a server application for receiving, displaying data, images or other information from said transceiver, as well as controlling said transceiver; providing a satellite data network; placing said at least one transceiver in an area served by said satellite data network; using said server application to receive data, images, or other information from said at least one transceiver and compiling said data into at least one database and/or folder on said server and to transmit control commands to said transceiver; providing a server having a data base, storage capacity, and said server application; providing an Internet network; coupling said satellite network and said server system to said Internet network; said at least one transceiver periodically sending said at least one transmission to said server via said satellite network and said Internet network to said server's data base and/or folders and, if available, downloading commands or files queued to be delivered to said transceiver; providing a personal computing device having display, control means, memory, and a database; coupling said personal computing device to said Internet network; using said personal computing device to interface with said server application in order to retrieve any new data, images, and/or information from said transceiver since the last time it interfaced with said server and to store said data, images, and/or information into a local database and/or folder on said personal computing device, and/or to generate control commands to be queued for delivery to said transceiver; appending said new data, images, and/or information to any previously downloaded data, images, and/or information in said database and/or local folders; coupling all of the said data, images, and/or information stored in said database and/or local folders with said personal computing device's web browsers or other local application to eliminate any delays associated with data transmission from said Internet server to said personal computing device.

2. The method of claim 1, wherein the satellite transceiver is a cellular transceiver and the satellite network is a cellular data or voice network.

3. The method of claim 1, wherein the satellite transceiver is a paging transceiver and the satellite network is a paging network.

4. The method of claim 1, wherein the satellite transceiver is a land line transceiver and the satellite network is a land line telephone network.

5. The method of claim 1, wherein the satellite transceiver is a WIFI transceiver and the satellite network is the Internet as provided by an Internet service provider.

6. The method of claim 1, wherein the satellite transceiver is an Ethernet transceiver and the satellite network is the Internet as provided by an Internet service provider.

7. A remote data transceiver, comprising: at least one data transceiver; at least one sensor, camera, or electrical switch; and, an Internet server with a server application for receiving, displaying data, images or other information from said transceiver, as well as controlling said transceiver; a satellite data network; a server having a data base, storage capacity, and said server application; an Internet network coupled to said satellite network and said server system; said at least one transceiver periodically sending said at least one transmission to said server via said satellite network and said Internet network to said server's data base and/or folders and, if available, downloading commands or files queued to be delivered to said transceiver; a personal computing device having display and control means coupled to said Internet network to interface with said server application in order to view said data and information from said transceiver, and/or to generate control commands to be queued for delivery to said transceiver; an interface between said personal computing device and said server application that can retrieve any new data, images, and/or information from said Internet server since the last time it interfaced with said server and to store said data, images, and/or information into a local database and/or folder on said personal computing device, and/or to generate control commands to be queued for delivery to said transceiver; an application running on said personal computing device that can append said new data, images, and/or information to any images, and/or information into said personal computing device's database and/or local folders downloaded previously from said server; coupling all of the said data, images, and/or information stored in said personal computing device's database and/or local folders with said personal computing device's web browsers or other local application to eliminate delays associated with data transmission from said Internet server to said personal computing device.

8. The system of claim 7, where the control commands include setting transceiver's power consumption mode, transmission rate, data logging rate, image logging rate, video frames per second rate, input/output port states, and high and low sensor alarm settings.

9. The system of claim 7, where the control commands include a file download command instructing the transceiver to download and/or execute a specific file from the server.

10. The system of claim 7, said at least one data transceiver further including a battery and solar panel for providing the electrical power requirements for said at least one data transceiver and peripheral devices.

11. An Internet server application comprising: a computer programming language text editor; a compiler for creating and compressing executables that will run properly on a target operating system running on an Internet-enabled data transceiver; a server-side emulator of the said transceiver coupled with said text editor and compiler for means of testing applications prior to loading onto said transceiver; a remote, Internet-enabled data transceiver that will download and/or execute said compressed executables when queued for delivery by said server application or when receiving a command message from said server application.

12. The system of claim 11, where said target operating system is running on a personal wireless device such as a cellular phone, gaming, or other device that can access the Internet.
